(19) United States
(12) Patent Application Publication
(10) Pub. No.: US 2006/0250926 A1
(43) Pub. Date: Nov. 9, 2006

(54) Apparatus and method for recording data on optical disc

(75) Inventor: Masayuki Mizuno, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/386,344

(22) Filed: Mar. 22, 2006

(30) Foreign Application Priority Data
Mar. 24, 2005 (JP) 2005-087104

(51) Int. Cl. G11B 7/00

(52) U.S. Cl. 369/100

(57) ABSTRACT

An optical-disc recording apparatus records an information signal on a loaded optical disc by emitting a laser beam towards the optical disc. The apparatus includes a detector that detects a characteristic of the optical disc based on a predetermined value obtained from light reflected from the optical disc; a laser-beam emitter that emits the laser beam towards the optical disc; a laser-beam driver that supplies a laser-beam driving signal to the laser-beam emitter; a power source that supplies a driving power to the laser-beam driver; and a controller that adjusts a voltage of the driving power supplied to the laser-beam driver in accordance with the detected characteristic of the optical disc.

### CROSS-REFERENCE TO RELATED APPLICATIONS

The present application claims priority from Japanese Patent Application No. JP 2005-087104 filed on Mar. 24, 2005, the disclosure of which is hereby incorporated by reference herein.

### BACKGROUND OF THE INVENTION

The present invention relates to an apparatus and method for recording compressed data, such as video data, on an optical disc.

In recent years, optical discs, such as DVDs (digital versatile discs), have been practically used as small-size recording media having high capacity for storing digital data, such as video and audio data. In contrast to video tapes, optical discs such as DVDs allow cuing by random access and also allow for easy editing. For these reasons, optical discs provide high operationality and are therefore becoming widely used for many purposes.

In the past, video camcorders having a combination of a video camera and a video tape recorder were used commonly both indoors and outdoors. On the other hand, in recent years, optical-disc recording apparatuses integrated with a camera that applies optical discs, such as DVDs, as recording media are commercially available. Using an optical disc as a recording medium improves the image quality and sound since digital data is recorded and played back. Moreover, the use of an optical disc enhances the storage stability of recording data and allows for easy connection with other audio-visual devices. There are several types of DVDs, but single-layer recording media are commonly used. Some examples of single-layer recording media are DVD-R and DVD+R (i.e. recordable discs), and DVD-RW and DVD+RW (i.e. rewritable discs). Although these types of recordable optical discs had a single-layer signal recording surface in the past, DVD+R optical discs in recent years are provided with a double-layer recording surface so that larger storage capacity is achieved in comparison to the single-layer type. Furthermore, such a double-layered structure is being developed for optical discs compliant with other standards, such as DVD-R.

In audio-visual devices that record moving image data onto an optical disc, such as DVD recorders, the recording of the data is implemented by emitting a laser beam towards the optical disc from a semiconductor laser diode contained in an optical pickup unit so as to form pits in the optical disc. In this case, a laser-beam driving IC (integrated circuit) supplies voltage and current to the semiconductor laser diode so that the laser beam is emitted from the laser diode. The voltage to be supplied to the laser diode is set based on the highest recording emission power. In other words, a laser-beam driving voltage is determined from its relationship with a preferred laser-beam driving current for the recording operation. This is due to the fact that the preferred laser-beam emission power for forming pits in the optical disc varies depending on the type of the optical disc. For example, at normal temperature, the preferred power on the disc surface is as follows: 14 to 16 mW for DVD-R/-RW, 18 to 19 mW for DVD+RW, and 25 to 27 mW for DVD+R/(-R) of double-layer type.

The laser-beam emission power and the laser-beam driving current correlate with each other, as shown in FIG. 9. FIG. 9 shows laser-beam-driving-current versus emission-power characteristics, where the vertical axis represents an emission power P_{O} and the horizontal axis represents a laser-beam driving current I_{F}. Referring to FIG. 9, when the laser-beam driving current I_{F} is below a predetermined threshold value Iₜₕ (range A), the emission power P_{O} increases very slightly, and therefore, the output intensity of the laser beam is very low. On the other hand, when the laser-beam driving current I_{F} exceeds the predetermined threshold value Iₜₕ (range B), the emission power P_{O} increases significantly, and therefore, the output intensity of the laser beam is very high. A laser-beam driving current preferred for this emission power is as follows: 200 to 220 mA for DVD-R/-RW, 240 to 280 mA for DVD+RW of single-layer type, and 360 to 400 mA for DVD+R/(-R) of double-layer type. Accordingly, in order to drive the laser diode, the laser-beam driving voltage may have to be increased as the driving current becomes higher. In the past, the laser-beam driving current was set in accordance with an optical disc needing the maximum emission power.

Although a laser-beam driving current is supplied from a laser-beam driving circuit of the laser-beam driving IC, the upper-limit current value is determined based on the laser-beam driving voltage. The upper-limit current value of the laser-beam driving current I_{F} and the laser-beam driving voltage correlate with each other as shown in FIG. 10. FIG. 10 shows laser-beam-driving-voltage versus laser-beam-driving-current I_{F} characteristics, where the vertical axis represents the laser-beam driving current and the horizontal axis represents the laser-beam driving voltage. Referring to FIG. 10, for example, if the laser diode outputs a laser beam in a state where the preferred minimum voltage necessary for driving the optical pickup unit is 2.8 V, the preferred laser-beam driving voltage is 3.7 V for DVD-R/-RW of single-layer type when the upper-limit current value of the laser-beam driving current I_{F} is 220 mA. Under the same condition, when the upper-limit current value of the laser-beam driving current I_{F} is 280 mA, the preferred laser-beam driving voltage is 4.2 V for DVD+RW of single-layer type. Furthermore, under the same condition, when the upper-limit current value of the laser-beam driving current I_{F} is 400 mA, the preferred laser-beam driving voltage is 5.1 V for DVD+R/(-R) of double-layer type.

Japanese Unexamined Patent Application Publication No. 2003-100040 (FIG. 1) discloses a technology for controlling a supply voltage of an optical-disc apparatus.

If the recording emission power is set to its highest condition, or in other words, for example, if the laser-beam driving voltage is set in correspondence to double-layer recording, 5.1 V is preferred for the laser-beam driving voltage. Consequently, in order to achieve a DVD recording apparatus that is capable of performing double-layer recording on, for example, DVD+R, the laser-beam driving circuit may need a supply voltage of 5.1 V. This supply voltage of 5.1 V is not a significant problem for stationary recording apparatuses that are supplied with commercial alternating current, but is an undesirably high supply voltage for, for example, a battery-driven disc recording apparatus integrated with a camera. Such a high supply voltage leads to high power consumption, thus shortening the battery life.

Accordingly, a DVD recording apparatus of a double-layer recordable type may need a higher supply voltage in comparison to a DVD recording apparatus of a single-layer recording type, and are thus problematic in leading to higher power consumption. Moreover, even with a DVD recording apparatus of a single-layer recording type, the laser diode may have to be driven with a relatively high supply voltage depending on the disc type. Consequently, providing such a DVD recording apparatus of a single-layer recording type with the capability to record such a disc type may lead to higher power consumption.

Accordingly, it is desirable to achieve low power consumption in an apparatus having the capability to record data on various types of recording media.

### SUMMARY OF THE INVENTION

According to an embodiment of the present invention, when recording an information signal onto an optical disc with a laser beam, the following steps are performed. First, a characteristic of the optical disc is detected based on a predetermined value obtained from light reflected from the optical disc. Then, a supply voltage for driving the laser beam is adjusted in accordance with the detected characteristic of the optical disc. Subsequently, a laser-beam driving signal is generated with the adjusted supply voltage.

Accordingly, the supply voltage for driving the laser beam is adjusted in accordance with the characteristic of the loaded recording medium so that the adjusted supply voltage is suitable for the recording medium.

Accordingly, for example, when recording data on a disc that only needs a low recording laser power, the supply voltage for driving the laser beam may be reduced. This implies that the supply voltage for driving the laser beam does not necessarily have to be set at a high value at all times, thereby advantageously achieving low power consumption.

### BRIEF DESCRIPTION OF THE DRAWINGS

FIG. 1 is a block diagram illustrating an internal structure of an optical-disc recording apparatus according to a first embodiment of the present invention;

FIG. 2 is a flow chart illustrating a process for setting an optimal laser-beam driving voltage based on temperature monitoring according to the first embodiment of the present invention;

FIG. 3 is a flow chart illustrating a process for test recording according to the first embodiment of the present invention;

FIG. 4 illustrates a relationship between temperature and laser-beam driving current according to the first embodiment of the present invention;

FIG. 5 is a flow chart illustrating a process for setting an optimal laser-beam driving voltage by monitoring the laser-beam driving current according to a second embodiment of the present invention;

FIG. 6 is a flow chart illustrating a process for setting an optimal laser-beam driving voltage based on determination of whether an optical disc is a single-layer or double-layer type according to a third embodiment of the present invention;

FIGS. 7A and 7B illustrate examples of FE-signal waveforms according to the third embodiment of the present invention;

FIG. 8 shows examples of laser-beam driving voltage values for different types of recording media according to the third embodiment of the present invention;

FIG. 9 illustrates a relationship between laser-beam driving current and laser-beam emission power in related art; and

FIG. 10 illustrates a relationship between laser-beam driving voltage and laser-beam driving current in related art.

### DETAILED DESCRIPTION

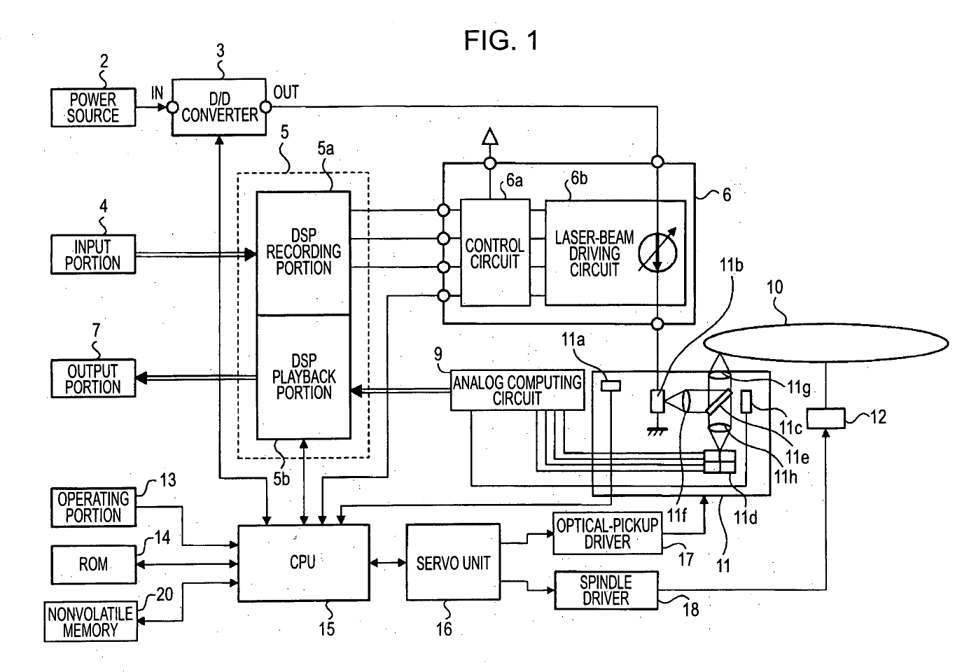

A first embodiment of the present invention will now be described with reference to FIGS. 1 to 4. The first embodiment is directed to an optical-disc recording apparatus integrated with a camera (which will be referred to as an optical-disc camcorder hereinafter) that records video data and audio data on an optical disc. In this embodiment, an optical disc compliant with DVD standard is used as a recording medium in the optical-disc camcorder.

An internal structure of an optical-disc camcorder 1 according to the first embodiment will be described below. FIG. 1 is a block diagram illustrating the internal structure of the optical-disc camcorder 1. The optical-disc camcorder 1 loads and unloads an optical disc 10 compliant with DVD standard, and has a function for recording and playing back data on the optical disc 10.

An operating portion 13 is manipulated by a user for operating the optical-disc camcorder 1, and is provided with, for example, recording buttons for starting and stopping a recording operation and cursor buttons for menu selection. An output portion 7 includes, for example, an LCD (liquid crystal display) panel, a viewfinder LCD, a speaker, and an external output terminal, and provides information for the user by displaying, for example, photographing/playback images, operation menu icons, and setting values.

When recording video/audio data, recording data is written onto the optical disc 10 by an optical pickup unit 11 having an optical system. In detail, when an image of an object is captured, a video signal generated by an input portion 4 is first input. The input portion 4 includes, for example, a microphone, a lens, and an imaging element, such as a CCD (charged-coupled device) imager, which are not shown. The input portion 4 converts analog data input as video/audio data to digital data, and sends the digital data to a DSP recording portion 5a included in a DSP (digital signal processor) 5, which is an integral circuit for data processing. The DSP recording portion 5a encodes the received data for file compression. The compressed data is subject to a conversion process based on MPEG-2 format (MPEG=Moving Picture Experts Group). The converted video data and audio data are processed to recording data compliant with DVD standard. The recording data is then sent to a laser-beam driver 6.

Specifically, the laser-beam driver 6 drives a laser diode 11b contained in the optical pickup unit 11. The laser-beam driver 6 includes a laser-beam driving circuit 6b that supplies a driving signal to the laser diode 11b, and a control circuit 6a that controls the laser-beam driving circuit 6b. Specifically, the control circuit 6a of the laser-beam driver 6 is supplied with a fixed voltage of, for example, 2.7 V as a supply voltage. The laser-beam driving circuit 6b receives power supplied from a D/D converter 3, which will be described later, and uses the power to produce the driving signal for the laser diode 11b under the control of the control circuit 6a. With respect to the power supplied from the D/D converter 3, a voltage value is set in an adjustable manner.

An electric-current value of the driving signal for the laser diode 11b is controlled by the control circuit 6a. On the other hand, the voltage value is determined from the supply voltage from the D/D converter 3. Based on the electric-current value and the voltage value, the laser power for recording or playback is set.

In response to the driving signal supplied to the laser diode 11b from the laser-beam driving circuit 6b, the laser diode 11b emits a laser beam. The emitted laser beam is collimated by passing through a lens 11f, and is then reflected perpendicularly by a polarizing beam splitter 11e. Subsequently, the laser beam is converged by an objective lens 11g so as to be focused on a recording layer of the optical disc 10. Accordingly, the data is recorded on the optical disc 10 by forming, for example, a pit on the recording layer thereof. The laser power from the laser diode 11b in the process of recording is detected by a front photo detector (FPD) 11c contained in the optical pickup unit 11, and is monitored by the control circuit 6a to determine whether the laser power is appropriate. Furthermore, feedback light from the optical disc 10 is supplied to a photo detector 11d, which will be described later, and servo control for driving the optical disc 10, such as tracking control, is implemented.

On the other hand, when playing back video/audio data, the optical pickup unit 11 reads the recording data on the optical disc 10. In detail, the driving signal supplied to the laser diode 11b from the laser-beam driving circuit 6b under the control of the control circuit 6a is set to a playback signal. A laser beam emitted from the laser diode 11b is collimated by passing through the lens 11f, and is reflected perpendicularly by the polarizing beam splitter 11e. Subsequently, the laser beam is converged by the objective lens 11g so as to be focused on the recording layer of the optical disc 10. Consequently, a reflected laser beam corresponding to, for example, a pit on the recording layer of the optical disc 10 is obtained.

The reflected laser beam is transmitted through a lens 11h so as to become focused on the photo detector 11d, which is sectioned into four components and performs photoelectric conversion. Four output signals from the photo detector 11d are thus sent to an analog computing circuit 9, which amplifies and computes (e.g. adds and subtracts) signals output from the optical pickup unit 11. Thus, the four output signals are totalized and are sent as a playback RF (radio frequency) signal to a DSP playback portion 5b for playback processing. The playback RF signal is given a predetermined decoding treatment so that the corresponding video/audio data is output to the output portion 7, whereby the video/audio data can be viewed and listened to by the user through the viewfinder LCD. Alternatively, the video/audio data may be sent to an external AV device via the external output terminal of the output portion 7.

When the video/audio data is being recorded or played back, the emission power of a laser beam is monitored by the front photo detector 11c serving as a light-receiving element. Furthermore, a laser beam reflected by the optical disc 10 is converged by the lens 11h, and is detected for differences in light intensity by two tracking photo-detector components and the four photo-detector components included in the photo detector lid for focus-servo operation and RF-signal generation, whereby signals for focus-servo control are produced.

A focus-error detecting signal and a tracking-error detecting signal generated by the photo detector 11d are sent to the analog computing circuit 9. The subtracted output signals from the tracking photo-detector components become tracking error (TE) signals. On the other hand, the output signals from the four photo-detector components are computed as focus error (FE) signals based on the astigmatic method, and at the same time, the sum of the output signals is computed as a playback RF signal. In addition to the playback RF signal, the FE signal, and the TE signal, the analog computing circuit 9 then sends, for example, a push-pull (PP) signal used for checking a wobble frequency and a pull-in (PI) signal for checking an absolute light intensity to the DSP playback portion 5b.

A DC power supplied from a power source 2, which may be a battery or an external power input terminal, is sent to the D/D converter 3 serving as a voltage converter for converting DC voltage. The D/D converter 3 is a circuit that produces a DC power of each voltage value for the optical-disc camcorder 1 according to the first embodiment. In this case, a DC voltage supplied by the D/D converter 3 to the laser-beam driving circuit 6b is set adjustably within a range of, for example, 3.7 V to 5.1 V. A CPU 15 serving as a controller for each of the blocks is connected to the D/D converter 3, the DSP 5, the control circuit 6a, a temperature sensor 11a, and a servo unit 16, and performs, for example, reception of values, computing, and issuing of control commands. The DC voltage supplied by the D/D converter 3 to the laser-beam driving circuit 6b is also set under the control of the CPU 15. Detection data of a disc-type is sent to the CPU 15 where the type of disc is identified. The temperature sensor 11a is included in the optical pickup unit 11 and monitors the temperature of the laser diode 11b and its vicinity. Temperature information detected by the temperature sensor 11a may be sent to the CPU 15 at any time. Based on the temperature of the optical pickup unit 11 (specifically, the laser diode 11b and its vicinity) during a recording operation on the optical disc 10, the laser-beam driving signal of the laser-beam driver 6 is adjusted.

Operation information from the operating portion 13 is supplied to the CPU 15 so that a control process is implemented. Based on, for example, the FE, TE, PP, and PI signals sent from the DSP playback portion 5b, the CPU 15 controls the servo unit 16. In response to the control operation of the servo unit 16, an optical-pickup driver 17 drives the optical system in the optical pickup unit 11, whereby servo operations, such as tracking-servo and focus-servo operations, are performed.

Furthermore, the CPU 15 controls a spindle driver 18 via the servo unit 16. The spindle driver 18 is for rotating a motor 12. By driving the motor 12 at an appropriate rate, the optical disc 10 is rotated. When playing back video/audio data, each signal obtained from the analog computing circuit 9 is sent to the CPU 15 via the DSP playback portion 5b. In this case, the CPU 15 measures the degree of the PP signal to determine whether the optical disc 10 has “+” or “-” recording properties. Moreover, the CPU 15 controls the control circuit 6a via the DSP recording portion 5a in order to drive the laser-beam driving circuit 6b.

The optical-disc camcorder 1 according to the first embodiment is also provided with a nonvolatile memory 20. The CPU 15 is capable of recording and playing back, for example, video data and audio data stored in the nonvolatile memory 20. Moreover, the nonvolatile memory 20 also stores user setting data, which can be read out at any time.

The optical pickup unit 11 has the temperature sensor 11a for monitoring the temperature of the laser diode 11b and its vicinity. The temperature information detected by the temperature sensor 11a may be sent to the CPU 15 at any time. Where necessary, the CPU 15 reads out an appropriate value from a ROM 14 storing, for example, electric-current characteristics corresponding to the temperature of the laser diode 11b, and controls the laser-beam driving circuit 6b.

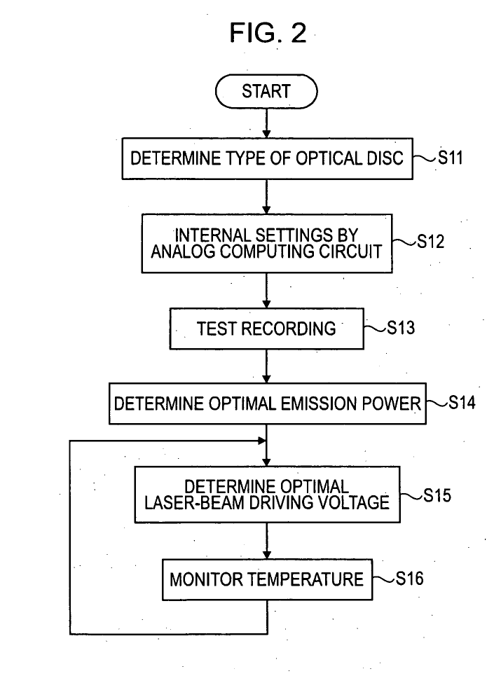

An example of a control operation for recording data on a disc in the optical-disc camcorder 1 according to the first embodiment will now be described with reference to a flow chart of FIG. 2.

In step S11, after the inserted optical disc 10 is detected, the type of optical disc is determined based on a detection of an S-shaped waveform of an FE signal, the reflectance of the optical disc 10, and a wobble signal frequency of a track. In detail, the optical disc 10 is determined to be a recordable disc or a playback-only disc, and if the optical disc 10 is a recordable disc, it is determined whether the optical disc 10 is a “+”, “-”, R, or RW type. In step S12, the analog computing circuit 9 sets, for example, a filter constant number and an amplifier gain based on the type of the optical disc 10.

In step S13, a test recording operation is performed. A test recording operation is for determining an optimal emission power of a laser beam. Specifically, in test recording, dummy data is obtained by varying the emission power of a laser beam emitted from the laser diode 11b, and is written into a power calibration area, which will be described later. Subsequently, in step S14, an optimal emission power for the optical disc 10 is determined.

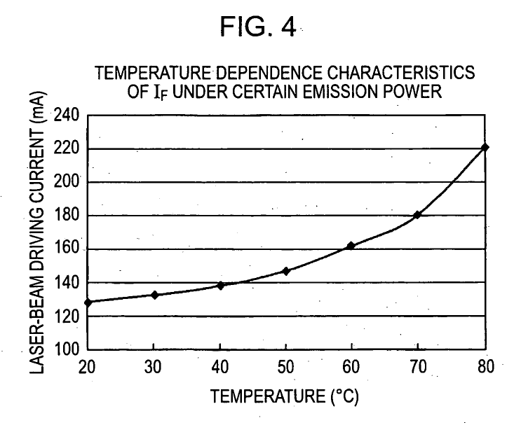

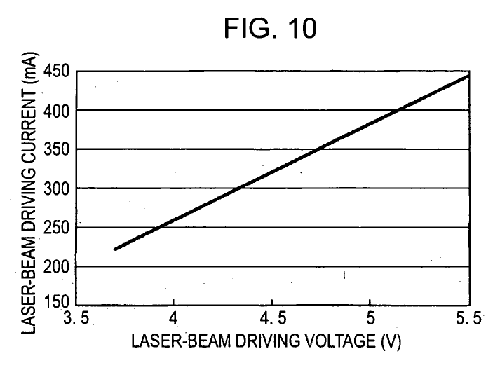

In step S15, based on the optimal emission power determined in step S14, an optimal DC voltage to be supplied to the laser-beam driving circuit 6b is determined. In step S16, while a laser beam is being emitted from the laser diode 11b, the temperature sensor 11a constantly monitors the temperature of the laser diode 11b and its vicinity. The optimal emission power of the laser beam is maintained by referring to temperature dependence data shown in FIG. 4, which will be described later in detail. Specifically, an optimal laser-beam driving current can be determined from a temperature value based on the temperature dependence data. Moreover, based on the current-voltage relationship shown in FIG. 10, feedback control is implemented to set an optimal laser-beam driving voltage.

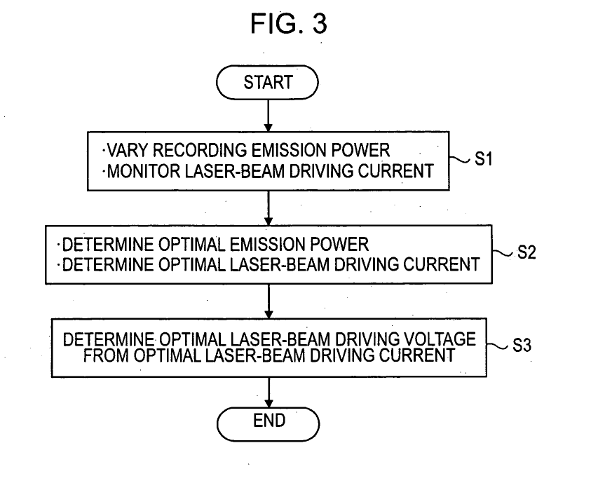

The test recording operation performed in step S13 will be described below in detail with reference to a flow chart shown in FIG. 3. In step S1, when the test recording is started, the dummy data obtained by varying the emission power of the laser beam emitted from the laser diode 11b is written into the power calibration area. At the same time, the CPU 15 monitors the laser-beam driving current with respect to the varied emission power of the laser diode 11b. In step S2, an optimal emission power for recording data on the optical disc 10 is determined. At the same time, an optimal laser-beam driving current is determined. In step S3, an optimal laser-beam driving voltage is determined from the value of this optimal laser-beam driving current. For determining an optimal laser-beam driving voltage, the CPU 15 may read out the characteristics of the relationship between the laser-beam driving voltage and the laser-beam driving current, as shown in FIG. 10, from the ROM 14.

In the process for determining the type of optical disc in step S11 in FIG. 2, the determination may be based on a detection of an FE signal. In other words, since the magnitude of the S-shaped-wave amplitude detected as an FE signal is proportional to the reflectance of the optical disc 10, an R medium and an RW medium having different reflectance can be distinguished from each other. Moreover, the optical disc 10 may be rotated at a fixed linear velocity so as to start focus-servo and tracking-servo operations. In that case, the optical disc 10 may be determined to be a “+” medium (+R/+RW) or a “-” medium (-R/-RW) from the frequency of a wobble signal appearing at an end of a PP signal.

Furthermore, referring to FIG. 9, the emission power and the laser-beam driving voltage correlate with each other, and such correlation data is stored in the ROM 14. On the other hand, the CPU 15 controls an output voltage of the D/D converter 3 based on the stored correlation data and the optimal emission power determined from test recording, and adjusts the laser-beam driving voltage for the corresponding optimal emission power value. Accordingly, the CPU 15 adjust the laser-beam driving voltage to a low supply voltage value for an optical disc that can be recorded with low emission power, thereby advantageously contributing to low power consumption.

The relationship between temperature values and laser-beam driving current values under a certain emission power will now be described with reference to FIG. 4. Generally, in order to attain a constant emission power with a laser diode, temperature dependence characteristics exist as shown in FIG. 4. It is clear that a greater laser-beam driving current may be necessary in accordance with an increase in the temperature of the laser diode. Therefore, in order to attain an appropriate emission power with the laser diode, a laser-beam driving current of 140 mA is necessary when the temperature is, for example, 40° C., and a laser-beam driving current of 180 mA is necessary when the temperate rises to 70° C.

The optical-disc camcorder 1 according to the first embodiment stores the temperature-dependence correlation data shown in FIG. 4 in the ROM 14. The CPU 15 controls the output voltage of the D/D converter 3 based on the temperature-dependence correlation data, the recording emission power detected by the front photo detector 11c, and the temperature detected by the temperature sensor 11a. Accordingly, the CPU 15 adjusts the laser-beam driving voltage in accordance with the emission power and the temperature.

For example, if an imaging operation is performed by the optical-disc camcorder 1 in a condition where the ambient temperature is about 40° C., the temperature of the laser diode 11b and its vicinity may possibly rise to about 70° C. Since the laser diode 11b may damage if the temperature exceeds 75° C., it is desirable to keep the temperature of the laser diode 11b below 75° C. Generally, even if the temperature of the laser diode 11b rises to 70° C., the temperature of other elements rarely rises to 70° C. In contrast to a playback operation of data, which may be performed under low emission power, a certain amount of emission power may be necessary for a recording operation of data. On the other hand, even if the playback and recording operations are performed under the same emission power, the preferred amount of laser-beam driving current may vary depending on a quality variation in laser diodes or a change in temperature. Furthermore, if the optical disc 10 is warped or curved, it may be necessary to increase the emission power.

Consequently, even if the optical-disc camcorder 1 according to the first embodiment is in a condition where it is difficult to attain a sufficient laser-beam emission power for a recording operation due to a temperature rise, an optimal laser-beam emission power is still attained by setting an optimal laser-beam driving current for that temperature.

Although a temperature sensor is used in typical optical-disc camcorders for detecting the temperature of a laser diode, a laser-beam driving voltage is not determined from temperature information, but is set to a voltage that allows maximum emission power. In contrast, according to the first embodiment, the laser-beam driving voltage is adjusted to an appropriate value based on the temperature information from the temperature sensor 11a, such that an optimal laser-beam driving voltage is set in accordance with that temperature. Consequently, this advantageously contributes to low power consumption. Moreover, by constantly monitoring the temperature, the recording operation, for example, may be terminated if the temperature of the laser diode 11b rises to about 75° C. This reduces the risk of damaging the laser diode 11b.

Furthermore, as a feature of the laser diode 11b, for example, the preferred laser-beam driving current may increase by about 20 percent when the temperature rises by 10° C. This may eliminate the need for an electric-current sensor that monitors the laser-beam driving current, such that the laser-beam driving voltage is adjusted automatically based only on the temperature detected by the temperature sensor 11a.

Furthermore, a warning may be displayed on the output portion 7 so as to allow the user to know the temperature condition inside the optical-disc camcorder 1. This allows the user to cool down the optical-disc camcorder 1 by changing the location, or to stop the operation in order to lower the temperature of the laser diode 11b.

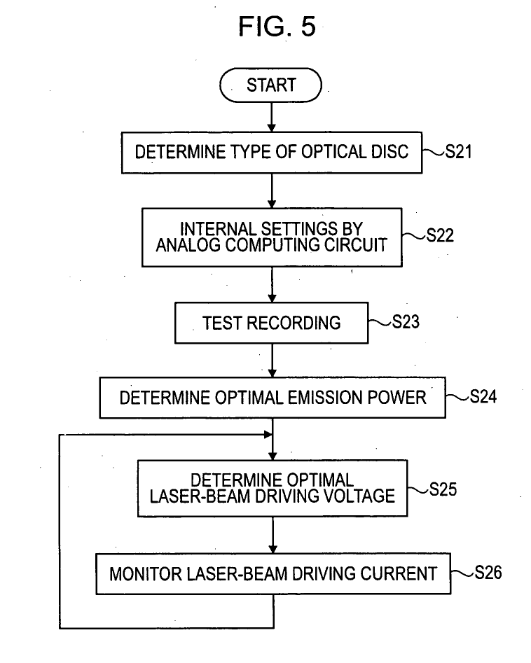

A second embodiment of the present invention will now be described with reference to FIG. 5. When recording data on the optical disc 10 in the second embodiment, an actual laser-beam driving current value is observed, and the laser-beam driving voltage of the laser-beam driver 6 is adjusted based on the observation result. The second embodiment is applied to substantially the same optical-disc camcorder 1 as the first embodiment. Moreover, similar to the first embodiment, an optical disc compliant with DVD standard is used as a recording medium in the optical-disc camcorder 1 according to the second embodiment.

The basic structure of the optical-disc camcorder 1 according to the second embodiment is substantially the same as the optical-disc camcorder 1 according to the first embodiment shown in FIG. 1. Therefore, detail descriptions of the components included in the optical-disc camcorder 1 will be omitted. According to the second embodiment, the laser-beam driving circuit 6b is provided with an electric-current sensor for a laser-beam driving signal, such that an electric-current value of a laser-beam driving signal is measured in the laser-beam driving circuit 6b. The laser-beam driving circuit 6b sends the measured electric-current value to the control circuit 6a. The control circuit 6a then sends the electric-current value data to the CPU 15.

An example of a process for setting a laser-beam driving signal according to the second embodiment will now be described with reference to a flow chart of FIG. 5. In step S21, after the inserted optical disc 10 is detected, the type of optical disc is determined based on a detection of an S-shaped waveform of an FE signal, the reflectance of the optical disc 10, and the frequency of a wobble signal. In detail, the optical disc 10 is determined to be “+”, “-”, R, or RW type. In step S22, the analog computing circuit 9 sets, for example, a filter constant number and an amplifier gain based on the type of the optical disc 10.

In step S23, the test recording operation shown in FIG. 3 is performed. As described above, the test recording operation is for determining an optimal emission power of a laser beam. Specifically, in test recording, dummy data is obtained by varying the emission power of a laser beam emitted from the laser diode 11b, and is written into a power calibration area. In step S24, an optimal emission power for the optical disc 10 is determined. For example, by using the electric-current sensor in the laser-beam driver 6 to measure the laser-beam driving current, an actual laser-beam driving current for the optimal recording emission power is determined.

In step S25, based on the determined optimal emission power, an optimal laser-beam driving voltage is determined. In step S26, while a laser beam is being emitted from the laser diode 11b, the laser-beam driver 6 constantly monitors the laser-beam driving current. In order to maintain the optimal emission power of the laser beam, feedback control is implemented to set an optimal laser-beam driving voltage from the measured laser-beam driving current value on the basis of the current-voltage relationship data shown in FIG. 10.

According to the second embodiment, the current-voltage relationship data shown in FIG. 10 is stored in the ROM 14. The CPU 15 controls an output voltage of the D/D converter 3 based on the current-voltage relationship data stored in the ROM 14 and the monitored laser-beam driving current, and adjusts the laser-beam driving voltage based on the corresponding laser-beam driving current value. Accordingly, the laser-beam driving voltage is reduced for an optical disc 10 that is recordable with low emission power, thereby advantageously contributing to low power consumption.

Alternatively, a combination of the monitoring control of the temperature sensor in the first embodiment for monitoring the temperature of the laser diode 11b and its vicinity and the monitoring of the driving current according to the second embodiment is also permissible.

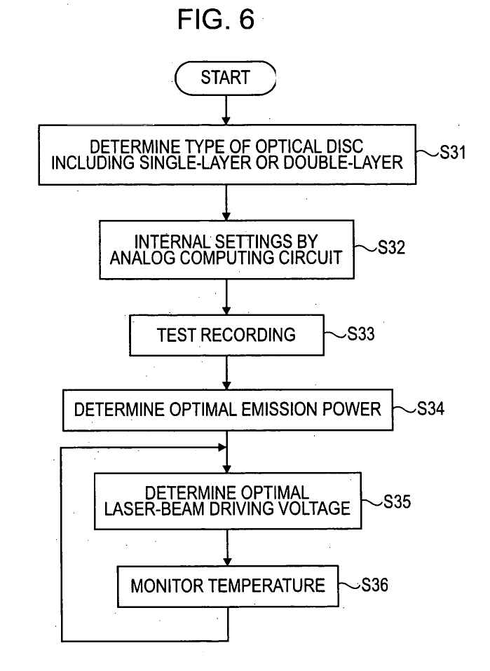

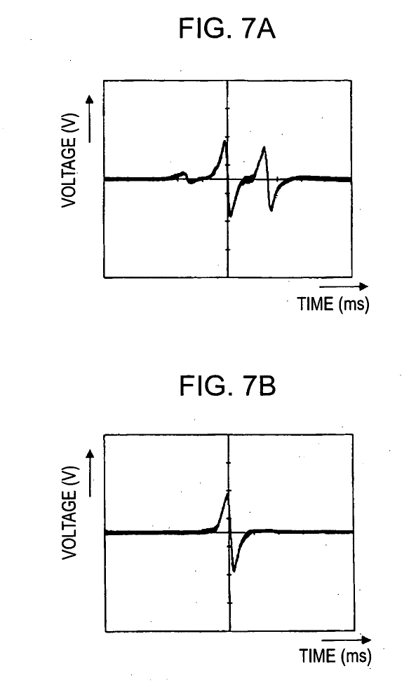

A third embodiment of the present invention will now be described with reference to FIGS. 6 and 7. The third embodiment is applied to substantially the same optical-disc camcorder 1 as the first embodiment. Moreover, similar to the first embodiment, an optical compliant with DVD standard is used as a recording medium in the optical-disc camcorder 1 according to the third embodiment.

The basic structure of the optical-disc camcorder 1 according to the third embodiment is substantially the same as the optical-disc camcorder 1 according to the first embodiment shown in FIG. 1. Therefore, detail descriptions of the components included in the optical-disc camcorder 1 will be omitted. In the third embodiment, the recordable optical disc 10 is directed to a single-layer disc having a single signal-recording layer and to a double-layer disc having two signal-recording layers.

An example of a process for setting a laser-beam driving signal according to the third embodiment will now be described with reference to a flow chart of FIG. 6.

In step S31, after the inserted optical disc 10 is detected, the type of optical disc is determined based on a detection of an S-shaped waveform of an FE signal, the reflectance of the optical disc 10, and a wobble signal frequency of a track. In detail, the optical disc 10 is determined to be a single-layer, double-layer, “+”, “-”, R, or RW type. This determination step will be described later in detail. In step S32, the analog computing circuit 9 sets, for example, a filter constant number and an amplifier gain based on the type of the optical disc 10.

In step S33, the test recording operation is performed. As described above, the test recording operation is for determining an optimal emission power of a laser beam. Specifically, in test recording, dummy data is obtained by varying the emission power of a laser beam emitted from the laser diode 11b, and is written into a power calibration area. In step S34, an optimal emission power for the optical disc 10 is determined.

In step S35, based on the determined optimal emission power, an optimal voltage to be supplied from the D/D converter 3 to the laser-beam driving circuit 6b is determined. In step S36, while a laser beam is being emitted from the laser diode 11b, the temperature sensor 11a constantly monitors the temperature of the laser diode 11b and its vicinity. In order to maintain the optimal emission power of the laser beam, an optimal laser-beam driving current is determined from the temperature value on the basis of the temperature dependence data shown in FIG. 4, and moreover, feedback control is implemented to set an optimal laser-beam driving voltage on the basis of the current-voltage relationship data shown in FIG. 10.

The determination step for determining the type of optical disc, which includes determining the number of layers, in step S31 of FIG. 6 will be described with reference to examples of FE-signal waveforms shown in FIGS. 7A and 7B. FIGS. 7A and 7B are diagrams each illustrating an FE signal detected as a basis for determining the type of optical disc. When determining the type of optical disc, a focus search operation is performed, such that an S-shaped waveform appearing at an end of an FE signal is observed, as shown in FIGS. 7A and 7B. FIGS. 7A and 7B respectively illustrate examples of S-shaped waveforms of FE signals obtained from double-layer and single-layer optical discs 10, where the vertical axis represents the voltage and the horizontal axis represents time.

If two continuous S-shaped waves are detected as shown in FIG. 7A, the optical disc 10 is determined to be a double-layer type. In contrast, if one S-shaped wave is detected as shown in FIG. 7B, the optical disc 10 is determined to be a single-layer type. Furthermore, since the magnitude of an S-shaped-wave amplitude is proportional to the reflectance of the optical disc 10, an R-medium and an RW-medium having difference reflectance can be distinguished from each other. Moreover, the optical disc 10 may be rotated at a certain linear velocity with respect to a radius position thereof so as to start focus-servo and tracking-servo operations. In that case, the optical disc 10 may be determined to be a “+” medium (+R/+RW) or a “-” medium (-R/-RW) from the frequency of a wobble signal appearing at an end of a PP signal.

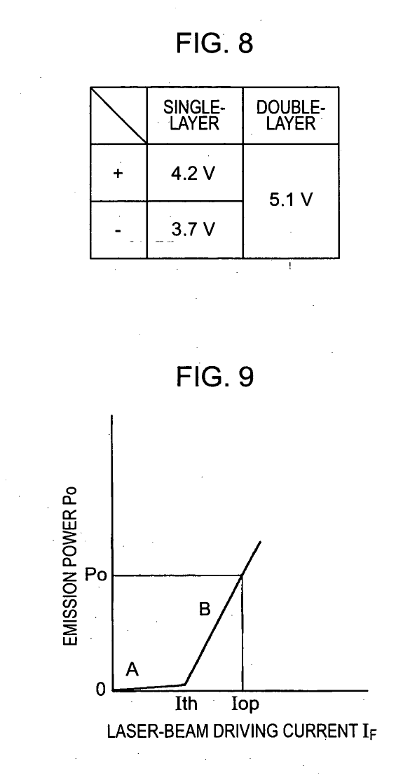

FIG. 8 shows examples of laser-beam driving voltage values output from the D/D converter 3 for different types of recording media during a recording operation. Referring to FIG. 8, if the optical disc 10 is a single-layer type with “+” format, the voltage is, set at, for example, 4.2 V. If the optical disc 10 is a double-layer type with “-” format, the voltage is set at, for example, 3.7 V. On the other hand, if the optical disc 10 is a double-layer type with “+” or “-” format, the voltage is set at 5.1 V.

Accordingly, whether the optical disc 10 is a single-layer or double-layer type with “+” or “-” format, an optimal laser-beam driving voltage is determined, thereby achieving low power consumption.

According to the first to third embodiments, the laser-beam driving voltage is adjusted based on the determined type of optical disc 10, the test recording result, and the determined optimal recording emission power. Accordingly, when recording data on the optical disc 10 with low recording emission power, the laser-beam driving voltage is lowered, thereby achieving low power consumption.

Furthermore, applying the first to third embodiments to a portable optical-disc recording apparatus, such as a camcorder, significantly contributes to a longer battery life since the laser-beam driving voltage is controllable in an adjustable fashion.

Although each of the first to third embodiments is mainly directed to a control operation of the laser-beam driving voltage for data recording, the adjustment of the laser-beam emission power between a recording operation of the optical disc 10 and a playback operation of the optical disc 10 may alternatively be achieved by changing the voltage supplied to the laser-beam driving circuit 6b. In that case, the adjustment does not have to be based on the type of optical disc 10 as long as the emission power for a playback operation is lower than the emission power for a recording operation. For example, the emission power for playback may be set at about 0.75 mW, meaning that the voltage supplied to the laser-beam driving circuit 6b is reduced significantly in comparison to the voltage for recording. Accordingly, by adjusting the laser-beam driving voltage between recording and playback operations, lower power consumption is achieved.

Furthermore, in the first to third embodiments, the laser-beam driving voltage may be set before the test recording operation instead of after the test recording operation. Specifically, this is based on the fact that a substantially optimal emission power of the laser diode 11b can be set for the type of optical disc 10 on the basis of LPP information or ADIP information decoded from a track wobble signal of the optical disc 10. Consequently, the laser-beam driving voltage for the laser-beam driver 6 may be set at the time when the type of optical disc 10 is determined.

Furthermore, in the first to third embodiments, although the emission power, the laser-beam driving current, and the laser-beam driving voltage preferred for each optical-disc type are preliminarily stored in the ROM 14, the input portion 4, for example, may alternatively be provided with a network interface, such that these parameter values may be obtained via the Internet. As a further alternative, these parameter values may be stored in the nonvolatile memory 20 from which these value are obtainable.

Furthermore, in the first to third embodiments, although predetermined processes are implemented after the determination of the type of optical disc 10, the laser-beam driving voltage may alternatively be controlled without this determining step on the basis of the optimal emission power obtained from test recording. This is advantageous in that the supply voltage is finely controlled. As a further alternative, since an optimal emission power is roughly determinable for each type of optical disc 10, the laser-beam driving voltage may be set at the time when the type of optical disc 10 is determined.

Furthermore, as described above, the laser-beam driving voltage is adjustably set based on the determined type of optical disc 10 in the first to third embodiments. Alternatively, for controlling the emission power, the laser-beam driving voltage may be adjustably set based on a parameter other than the type of optical disc 10, such as a detection result of a unique characteristic of the optical disc 10.

Furthermore, although each embodiment is directed to an optical-disc recording/playback apparatus integrated with a camera, which is referred to as an optical-disc camcorder, each embodiment may alternatively be applied to, for example, a stationary optical-disc recording/playback apparatus. Moreover, although each embodiment is directed to an apparatus that records data on a disc compliant with DVD standard, each embodiment may alternatively be directed to an apparatus that records data on discs compliant with other standards.

It should be understood by those skilled in the art that various modifications, combinations, sub-combinations and alterations may occur depending on design requirements and other factors insofar as they are within the scope of the appended claims or the equivalents thereof.

1. An optical-disc recording apparatus that records an information signal on a loaded optical disc by emitting a laser beam towards the optical disc, the apparatus comprising:
a detector that detects a characteristic of the optical disc based on a predetermined value obtained from light reflected from the optical disc;
a laser-beam emitter that emits the laser beam towards the optical disc;
a laser-beam driver that supplies a laser-beam driving signal to the laser-beam emitter;
a power source that supplies a driving power to the laser-beam driver; and
a controller that adjusts a voltage of the driving power supplied to the laser-beam driver in accordance with the detected characteristic of the optical disc.

2. The optical-disc recording apparatus according to claim 1, wherein the characteristic of the optical disc detected by the detector includes the type of optical disc.

3. The optical-disc recording apparatus according to claim 1, wherein the characteristic of the optical disc detected by the detector includes the number of recording layers included in the optical disc.

4. The optical-disc recording apparatus according to claim 1, wherein the predetermined value obtained from the reflected light includes at least one of a waveform of a focus-error signal, the reflectance of the optical disc, and a wobble frequency of a track.

5. The optical-disc recording apparatus according to claim 1, wherein
the laser-beam emitter performs a test recording operation in which dummy data is written into a calibration area of the optical disc, and
the controller determines a recording emission power suitable for the optical disc on the basis of a laser-beam emission power value obtained from the test recording operation, and sets the voltage of the driving power supplied from the power source to the laser-beam driver.

6. The optical-disc recording apparatus according to claim 1, further comprising an electric-current sensor that detects an electric current of the laser-beam driving signal supplied to the laser-beam emitter from the laser-beam driver,
wherein the controller determines an emission power suitable for a recording operation on the optical disc in accordance with a change in the electric current detected by the electric-current sensor, and sets the voltage of the driving power supplied from the power source to the laser-beam driver.

7. The optical-disc recording apparatus according to claim 1, further comprising a temperature sensor that detects the temperature of the laser-beam emitter and a vicinity thereof,
wherein the controller determines an emission power suitable for a recording operation on the optical disc in accordance with a change in the temperature detected by the temperature sensor, and sets the voltage of the driving power supplied from the power source to the laser-beam driver.

8. A method for recording an information signal onto an optical disc by emitting a laser beam towards the optical disc, the method comprising:
detecting a characteristic of the optical disc based on a predetermined value obtained from light reflected from the optical disc;
adjusting a supply voltage for driving the laser beam in accordance with the detected characteristic of the optical disc; and
generating a laser-beam driving signal with the adjusted supply voltage.
